(19) United States
(12) Patent Application Publication
(10) Pub. No.: US 2017/0263386 A1
(43) Pub. Date: Sep. 14, 2017

(54) NEGATIVE ELECTRODE MATERIAL FOR POWER STORAGE DEVICE, MANUFACTURING METHOD THEREOF, AND LITHIUM ION POWER STORAGE DEVICE

(71) Applicant: Sumitomo Electric Industries, Ltd., Osaka-shi (JP)

(72) Inventors: Shinji Ishikawa, Yokohama-shi (JP); Kazuya Kuwahara, Yokohama-shi (JP); Takahiro Saito, Yokohama-shi (JP)

(21) Appl. No.: 15/505,818

(22) PCT Filed: Aug. 28, 2015
(86) PCT No.: PCT/JP2015/074484

§ 371 Date: Feb. 22, 2017

(30) Foreign Application Priority Data
Aug. 29, 2014 (JP) 2014-175144

(51) Int. Cl. H01G 11/32; H01G 11/52; H01G 11/62; H01M 4/04; H01M 4/587; H01M 10/0525; H01M 4/133; H01G 11/26; H01G 11/86

(52) U.S. Cl. CPC H01G 11/32; C01B 31/10; H01G 11/26; H01G 11/52; H01G 11/62; H01G 11/86; H01M 4/587; H01M 10/0525; H01M 4/133; H01M 4/0471; C01P 2006/12; C01P 2006/16; C01P 2006/14; C01P 2002/74; C01P 2002/78; C01P 2002/60; C01P 2006/40; H01M 2004/021

(57) ABSTRACT

A negative electrode material for a power storage device contains a single-phase porous carbon material capable of electrochemically occluding and releasing lithium ions, the single-phase porous carbon material has a BET specific surface area of not less than 100 m²/g, and a cumulative volume of pores having a pore diameter of 2 nm to 50 nm in a pore diameter distribution of the single-phase porous carbon material is not less than 25% of a total pore volume.

### TECHNICAL FIELD

The present invention relates to a negative electrode material for use in lithium ion power storage devices such as a lithium ion secondary battery and a lithium ion capacitor.

### BACKGROUND ART

While the environmental issues are coming to the fore, development of systems that convert clean energy such as sunlight or wind power to electric power and stores the electric power as electric energy has been actively conducted. As such power storage devices, lithium ion power storage devices such as a lithium ion secondary battery and a lithium ion capacitor have been known. In recent years, expansion of lithium ion power storage devices to application in which high electric power is instantaneously consumed, such as an electric vehicle and a hybrid vehicle, has also been accelerating. Thus, there is a demand for development of a negative electrode material with which high output can be achieved.

As the negative electrode materials of a lithium ion secondary battery and a lithium ion capacitor, graphite is generally used. A reaction between graphite and lithium ions is a Faradaic reaction associated with generation of an intercalation compound and change in an interlayer distance, and it is difficult to considerably improve the reaction resistance thereof. Thus, improvement of the output characteristics of a negative electrode is limited as long as graphite is used.

Therefore, Patent Literature 1 and 2 each proposes using, as a negative electrode material, a material obtained by coating the surface of activated carbon having a large BET specific surface area with a heat-treated product of pitch. With activated carbon solely, it is difficult to charge and discharge lithium ions. However, by forming a coating layer of the heat-treated product of the pitch on the surfaces of activated carbon particles, the initial efficiency is improved, and this material is more advantageous than graphite in terms of high-efficiency discharge.

Patent Literature 3 proposes using, as a negative electrode material, a carbon complex of carbon particles as a core and fibrous carbon having a graphene structure formed on the surfaces of and/or within the carbon particles. The total mesopore volume of the carbon complex is 0.005 to 1.0 cm³/g, and mesopores having a pore diameter of 100 to 400 angstroms account for 25% or more of the total mesopore volume.

### CITATION LIST

### Patent Literature

PATENT LITERATURE 1: Japanese Laid-Open Patent Publication No. 2001-229926

PATENT LITERATURE 2: Japanese Laid-Open Patent Publication No. 2003-346803

PATENT LITERATURE 3: Japanese Laid-Open Patent Publication No. 2008-66053

### SUMMARY OF INVENTION

### Technical Problem

Each of the negative electrode materials of Patent Literature 1 to 3 is a carbon complex containing a carbon material having a large irreversible capacity, and the initial efficiency is still low as compared to graphite, so that the negative electrode materials are not practical. In particular, in Patent Literature 1 and 2, since the surface of the activated carbon is coated with the heat-treated product of the pitch, mesopores effective for charging and discharging of lithium ions are inferred to be lost. In addition, with a complicated manufacturing method in which expensive activated carbon is used or a transition metal catalyst is used to cause fibrous carbon to grow, it is difficult to reduce the cost of the negative electrode material. With the negative electrode material of Patent Literature 3, impurities that are a transition metal easily remain, and there is also a problem that when the metal impurities remain, a side reaction with an electrolyte occurs.

### Solution to Problem

In view of the above, one aspect of the present invention proposes a negative electrode material for a power storage device, containing a single-phase porous carbon material capable of electrochemically occluding and releasing lithium ions, wherein the single-phase porous carbon material has a BET specific surface area of not less than 100 m²/g, and a cumulative volume (mesopore volume) of pores (mesopores) having a pore diameter of 2 nm to 50 nm in a pore diameter distribution of the single-phase porous carbon material is not less than 25% of a total pore volume.

Another aspect of the present invention is directed to a method for manufacturing a negative electrode material for a power storage device, the method comprising: (i) a step of activating a carbon precursor in which a graphite structure grows at a temperature of not higher than 1500° C., into a porous structure; and (ii) heating the activated carbon precursor at a temperature at which the graphite structure grows, to cause the graphite structure to grow to generate a single-phase porous carbon material.

Still another aspect of the present invention is directed to a lithium ion power storage device comprising: a positive electrode containing a positive electrode active material; a negative electrode containing a negative electrode active material; a separator interposed between the positive electrode and the negative electrode; and a nonaqueous electrolyte containing a salt of an anion and a lithium ion, wherein the negative electrode active material contains the above negative electrode material for the power storage device.

### Advantageous Effects of Invention

The present invention provides a practical negative electrode material suitable for movement of lithium ions and having a pore structure, and a lithium ion power storage device with high output can be obtained by using the negative electrode material.

### BRIEF DESCRIPTION OF DRAWINGS

FIG. 1 is a cross-sectional view schematically showing the configuration of a lithium ion power storage device (lithium ion capacitor) according to an embodiment of the present invention.

FIG. 2 is a diagram showing influence of a chlorination temperature on an X-ray diffraction image of a single-phase porous carbon material (derived from TiC).

FIG. 3 is a diagram showing a relationship between the crystallite size of graphite contained in the single-phase porous carbon material (derived from TiC) and a plane interval of a (002) plane.

FIG. 4 is a diagram showing a relationship between the chlorination temperature and the BET specific surface area of each single-phase porous carbon material.

FIG. 5 is a diagram showing a relationship between the chlorination temperature and the volume of mesopores formed in each single-phase porous carbon material.

FIG. 6 is a diagram showing a relationship between the chlorination temperature and the total pore volume of each single-phase porous carbon material.

FIG. 7 is a diagram showing a pore diameter distribution analyzed by a QSDFT method.

FIG. 8 is a diagram showing a pore diameter distribution analyzed by the QSDFT method.

### DESCRIPTION OF EMBODIMENTS

[Explanation of Embodiments of Present Invention]

First, contents of embodiments of the present invention will be listed for description.

(1) A negative electrode material for a power storage device according to an embodiment of the present invention contains a single-phase porous carbon material capable of electrochemically occluding and releasing lithium ions. The single-phase porous carbon material has a BET specific surface area of not less than 100 m²/g. A cumulative volume (mesopore volume) of pores (mesopores) having a pore diameter of 2 nm to 50 nm in a pore diameter distribution of the single-phase porous carbon material is not less than 25% of a total pore volume. The above pore structure is suitable for movement of lithium ions, so that the reaction resistance is low and charging and discharging with high output are possible.

(2) An X-ray diffraction image of the single-phase porous carbon material having the above pore structure has a peak (P₀₀₂) ascribed to a (002) plane of graphite. Here, a plane interval (d₀₀₂) of the (002) plane obtained from a position of the peak P₀₀₂ is preferably 0.340 nm to 0.370 nm, a crystallite size of the graphite obtained from a half width of the peak P₀₀₂ is preferably 1 nm to 20 nm. That is, the single-phase porous carbon material has a graphite structure and the crystallite size of the graphite is moderately small. (3) The total pore volume of the single-phase porous carbon material is preferably 0.3 cm³/g to 1.2 cm³/g.

(4) The pore diameter distribution of the single-phase porous carbon material has at least one pore distribution peak in a region of 2 nm to 5 nm in pore distribution analysis in QSDFT analysis that assumes a carbon slit structure.

(5) A method for manufacturing a negative electrode material for a power storage device according to an embodiment of the present invention includes: (i) a step of activating a carbon precursor in which a graphite structure grows at a temperature of not higher than 1500° C., into a porous structure; and (ii) heating the activated carbon precursor (hereinafter, carbon intermediate) at a temperature at which the graphite structure grows, to cause the graphite structure to grow to generate a single-phase porous carbon material.

(6) In the case where the carbon precursor is easily-graphitizable carbon, the activation can include a step of heating the carbon precursor at a temperature of lower than 1100° C. (e.g., not higher than 900° C.) in an atmosphere containing water vapor and/or carbon dioxide (hereinafter, H/C gas). In this case, (7) the easily-graphitizable carbon is preferably generated by carbonizing a precursor at a temperature of lower than 1000° C.

(8) In the case where the carbon precursor is a metal carbide, the activation can include a step of heating the metal carbide at a first temperature in an atmosphere containing chlorine (hereinafter, low-temperature chlorination).

In this case, (9) after the activation, a step of heating the carbon intermediate in a substantially oxygen-free atmosphere at a second temperature higher than the first temperature (that is, at a temperature at which the graphite structure grows) is preferably performed as the step of causing the graphite structure to grow. Accordingly, the pore structure changes with the growth of the graphite structure, and the volume of mesopores suitable for movement of lithium ions increases.

(10) In the case where the carbon precursor is a metal carbide, the activation can include a step of heating the metal carbide in an atmosphere containing chlorine at a temperature at which the graphite structure grows (hereinafter, high-temperature chlorination). In this case, during the activation, growth of the graphite structure proceeds in parallel.

(11) The metal carbide is preferably a carbide containing at least one metal of metals that belong to any of 4A, 5A, 6A, 7A, 8, and 3B groups in a short-form periodic table. (12) The metal contained in the metal carbide is preferably at least any one of titanium, aluminum, and tungsten.

(13) The carbon intermediate preferably has a BET specific surface area of not less than 1000 m²/g. This is because the total pore volume of the carbon intermediate easily becomes large.

With the above manufacturing method, (14) a negative electrode material can be efficiently manufactured in which the single-phase porous carbon material has a BET specific surface area of not less than 100 m²/g and a cumulative volume of pores having a pore diameter of 2 nm to 50 nm in a pore diameter distribution of the single-phase porous carbon material is not less than 25% of a total pore volume. In addition, (15) a negative electrode material can be efficiently manufactured in which an X-ray diffraction image of the single-phase porous carbon material has, at approximately 26°, a peak ascribed to a (002) plane of graphite, an average of a plane interval of the (002) plane obtained from a position of the peak is 0.340 nm to 0.370 nm, and a crystallite size of the graphite obtained from a half width of the peak is 1 nm to 20 nm. Furthermore, (16) a negative electrode material having a total pore volume of 0.3 cm³/g to 1.2 cm³/g can be efficiently manufactured.

(17) A negative electrode material having at least one pore distribution peak in a region of 2 nm to 5 nm in pore distribution analysis in QSDFT analysis that assumes a carbon slit structure can be efficiently manufactured.

(18) The manufacturing method may further include a step of heating the single-phase porous carbon material in a temperature range of 500° C. to 800° C. in an atmosphere containing water vapor and/or hydrogen, after the step of causing the graphite structure to grow.

(19) A lithium ion power storage device according to an embodiment of the present invention includes: a positive electrode containing a positive electrode active material; a negative electrode containing a negative electrode active material; a separator interposed between the positive electrode and the negative electrode; and a nonaqueous electrolyte containing a salt of an anion and a lithium ion. By the negative electrode active material containing the above negative electrode material, a lithium ion power storage device having high output is obtained.

### Details of Embodiment of Invention

Hereinafter, embodiments of the present invention will be specifically described with reference to the drawings as appropriate. The present invention is not limited to the following example and is indicated by the appended claims, and all changes which come within the meaning and range of equivalency of the claims are therefore intended to be embraced therein.

[Single-Phase Porous Carbon Material]

A negative electrode material for a power storage device according to an embodiment of the present invention contains a single-phase porous carbon material capable of electrochemically occluding and releasing lithium ions. Here, the “single-phase” porous carbon material means not to be a complex of a plurality of types of carbon materials having physical properties different from each other. Thus, in one aspect, the single-phase porous carbon material means a porous carbon material that does not have a multilayer structure such as a core-shell structure and is not a complex of particles and fibrous carbon.

(Specific Surface Area)

The BET specific surface area of the single-phase porous carbon material is not less than 100 m²/g. When the BET specific surface area is less than 100 m²/g, it is difficult to achieve a pore structure suitable for movement of lithium ions. A preferable lower limit of the BET specific surface area is, for example, 200 m²/g, 300 m²/g, or 400 m²/g. Even when the BET specific surface area is excessively large, it is difficult to achieve a pore structure suitable for movement of lithium ions in some cases. Thus, a preferable upper limit of the BET specific surface area is, for example, 1200 m²/g, 1000 m²/g, 800 m²/g, 600 m²/g, or 500 m²/g. These upper limits and these lower limits can be arbitrarily combined. A preferable range of the BET specific surface area, for example, can be 400 m²/g to 1200 m²/g, can be 200 m²/g to 1200 m²/g, and can be 300 m²/g to 800 m²/g. That is, the specific surface area of the single-phase porous carbon material is much larger than those of artificial graphite and natural graphite, and can be said to be close to that of activated carbon.

(Pore Structure)

In a pore diameter distribution of the single-phase porous carbon material, the cumulative volume (mesopore volume) of pores (mesopores) having a pore diameter of 2 nm to 50 nm is not less than 25% of the total pore volume. When the mesopore volume is less than 25% of the total pore volume, the ratio of the mesopore volume is low, so that movement of lithium ions is inhibited and charging and discharging with sufficiently high output become difficult. A preferable lower limit of the ratio of the mesopore volume is, for example, 30%, 35%, 40%, or 50%, and a preferable upper limit thereof is, for example, 90%, 80%, 75%, or 70%. These upper limits and these lower limits can be arbitrarily combined. A preferable range of the ratio of the mesopore volume, for example, can be 30% to 80% and can also be 35% to 75%. Thus, a reaction with lithium ions further easily occurs.

The total pore volume of the single-phase porous carbon material is preferably 0.3 cm³/g to 1.2 cm³/g, and is preferably 0.4 cm³/g to 1.1 cm³/g, 0.5 cm³/g to 1 cm³/g, or 0.6 cm³/g to 1 cm³/g. Thus, a solvent of an electrolyte easily permeates into the single-phase porous carbon material, so that it is further easy to increase output.

The pore diameter distribution of the single-phase porous carbon material preferably has at least one pore distribution peak in a range of 2 nm to 5 nm in pore distribution analysis in a QSDFT analysis that assumes a carbon slit structure, based on an obtained adsorption isotherm. By using such a single-phase porous carbon material as a negative electrode material, it is possible to form a structure in which a movement path for moving ion in the electrolyte is ensured, so that it is easy to increase output.

The BET specific surface area is a specific surface area obtained by a BET method. Here, the BET method is a method in which an adsorption isotherm is measured by causing the single-phase porous carbon material to adsorb and desorb nitrogen gas, and measurement data is analyzed on the basis of a predetermined BET formula. The pore diameter distribution of the single-phase porous carbon material is calculated by a BJH method (Barrett-Joyner-Halenda method) from the adsorption isotherm using nitrogen gas. The total pore volume and the ratio of the mesopore volume can be calculated from the pore diameter distribution. An example of a commercially available measuring device for measuring the BET specific surface area and the pore diameter distribution is BELLSORP-mini II manufactured by Bell Japan, Inc.

The QSDFT analysis is an analysis method based on a quenching fixed density functional theory appended as a pore analysis function to a measuring device (e.g., Autosorb, Nova 2000) manufactured by Quantachrome Instruments, and is suitable for accurately analyzing the pore diameter of porous carbon.

(Crystal Structure)

An X-ray diffraction image of the single-phase porous carbon material by Cu Kα radiation has, at approximately 26°, a peak (P₀₀₂) ascribed to the (002) plane of graphite. That is, the single-phase porous carbon material partially has a graphite structure unlike activated carbon. Thus, a reaction with lithium ions easily occurs, and the reversible capacity easily becomes large. However, the graphite structure of the single-phase porous carbon material has not developed as much as those of natural graphite and artificial graphite.

Specifically, an average (d₀₀₂) of the plane interval of the (002) plane obtained from the position of the peak P₀₀₂ of the single-phase porous carbon material is 0.340 nm to 0.370 nm and is preferably 0.340 nm to 0.350 nm. The plane interval of the (002) plane of graphite whose graphite structure has sufficiently developed is about 0.335 nm.

The crystallite size of the graphite of the single-phase porous carbon material is moderately small, and a crystallite size of the graphite obtained from the half width of the peak P₀₀₂ is 1 nm to 20 nm and is preferably 2 nm to 7 nm or 3 nm to 6 nm.

The plane interval (d₀₀₂) and the crystallite size are obtained by analyzing the peak appearing at approximately 20=26° in the X-ray diffraction image. The X-ray diffraction image includes noise. Thus, the background of the X-ray diffraction image is removed, the peak is standardized, and then the analysis is performed. The plane interval (d₀₀₂) is obtained by a formula: d₀₀₂=λ/2 sin (θx) from the position (2θx) of the midpoint of the peak width at ⅔ of the height of the peak (P₀₀₂). The crystallite size (Lc) is obtained by using a formula: Lc=λ/β cos (θx) 9.1/β from the peak width (half width β) at ½ of the height of the peak (P₀₀₂).

[Manufacturing Method of Negative Electrode Material]

A method for manufacturing a negative electrode material for a power storage device according to an embodiment of the present invention includes: (i) a step of activating a carbon precursor in which a graphite structure grows at a temperature of not higher than 1500° C., into a porous structure; and (ii) heating the activated carbon precursor (carbon intermediate) at a temperature at which the graphite structure grows (e.g., 1000° C. to 1500° C. or 1200° C. to 1500° C.), to cause the graphite structure to grow to generate a single-phase porous carbon material. With the above method, it is possible to obtain, at low cost, the above single-phase porous carbon material capable of electrochemically occluding and releasing lithium ions.

The carbon precursor is preferably a material in which a graphite structure moderately grows at 1500° C. or lower. Thus, an X-ray diffraction image of the carbon precursor by Cu Kα radiation may not have a peak (P₀₀₂) ascribed to the (002) plane of graphite. In addition, even when the carbon precursor has a peak (P₀₀₂), the average (d₀₀₂) of the plane interval of the (002) plane is preferably not less than 0.360 nm and more preferably not less than 0.370 nm. The crystallite size of the carbon precursor is preferably less than 1 nm.

The BET specific surface area of the carbon intermediate obtained by the activation is preferably not less than 1000 m²/g. By increasing the BET specific surface area of the carbon intermediate as described above, a single-phase porous carbon material having a large total pore volume and a high ratio of mesopores is easily obtained.

In the step (ii) of causing the graphite structure to grow, the pore structure changes with the growth of the graphite structure, and the volume of the mesopores suitable for movement of lithium ions increases. At this time, when the heating temperature is excessively high, the specific surface area tends to be small. In addition, when the graphite structure excessively grows, the pore structure changes to decrease the total pore volume in some cases. Thus, the heating temperature is preferably not higher than 1500° C.

A step of heating the single-phase porous carbon material in a temperature range of 500° C. to 800° C. in an atmosphere containing water vapor and/or hydrogen after the graphite structure is caused to grow, may be included. For example, the single-phase porous carbon material may be heated in a mixed gas atmosphere of hydrogen and inert gas. Thus, a higher-purity single-phase porous carbon material is obtained. For example, even when a small amount of chlorine remains in the single-phase porous carbon material manufactured through the chlorination, such chlorine is removed.

Hereinafter, specific embodiments of the above manufacturing method will be described.

### First Embodiment

In the present embodiment, easily-graphitizable carbon is used as the carbon precursor, and the activation is performed in an atmosphere containing water vapor and/or carbon dioxide (hereinafter, H/C gas).

As the easily-graphitizable carbon, carbonized products of various precursors, coke, thermally decomposed vapor grown carbon, mesocarbon microbeads, and the like may be used. As the precursors for the carbonized products, for example, a condensed polycyclic hydrocarbon compound, a condensed heterocyclic compound, a ring-linked compound, aromatic oil, and pitch may be used. Among those described above, pitch is preferable since pitch is cheap. Examples of pitch include petroleum pitch and coal pitch. Examples of the condensed polycyclic hydrocarbon compound include condensed polycyclic hydrocarbons having two or more rings such as naphthalene, fluorene, phenanthrene, and anthracene. Examples of the condensed heterocyclic compound include condensed heterocyclic compounds having three or more rings such as indole, quinolone, isoquinoline, and carbazole. In carbonizing the precursor, the precursor may be baked, for example, at 1000° C. or lower in a pressure-reduced atmosphere or in an atmosphere of inert gas (N₂, He, Ar, Ne, Xe, etc. The same applies hereinafter).

The activation (i) using H/C gas can include a step of heating the carbon precursor at a temperature of not higher than 1100° C. in an H/C gas atmosphere (H/C gas treatment). In the H/C gas treatment, a chemical agent is not used, so that impurities are not mixed in and the work process is also simple. Thus, a carbon intermediate having a large specific surface area and a large total pore volume can be obtained at low cost. When the heating temperature exceeds 1100° C., a reaction between H/C gas and carbon becomes fast, surface etching of the carbon precursor easily proceeds, decrease of the particle diameter proceeds rather than increase of the specific surface area, and the activation yield decreases in some cases.

In an atmosphere containing water vapor at a higher concentration than that of carbon dioxide, the carbon precursor is preferably activated at 800° C. to 900° C. In an atmosphere containing carbon dioxide at a higher concentration than that of water vapor, the carbon precursor is preferably activated at 1000° C. to 1100° C. Thus, a carbon intermediate having a BET specific surface area of not less than 1000 m²/g is easily obtained.

In the step (ii) of causing the graphite structure to grow, the carbon intermediate is heated in a substantially oxygen-free atmosphere at a temperature at which the graphite structure grows (e.g., 1100° C. to 1500° C.). Thus, the pore structure changes with the growth of the graphite structure, and the volume of the mesopores suitable for movement of lithium ions increases. Here, the oxygen-free atmosphere is a pressure-reduced atmosphere or an inert gas atmosphere, and the mole fraction of oxygen therein may be less than 0.1%. The heating temperature depends on the state of the carbon intermediate, but is preferably not lower than 1200° C. and further preferably not lower than 1300° C.

### Second Embodiment

In the present embodiment, a metal carbide is used as the carbon precursor, and the activation is performed in an atmosphere containing chlorine. Since the metal carbide is a material that is less likely to contain impurities itself, the generated single-phase porous carbon material has high purity and the amount of impurities contained therein can be made very low.

The metal carbide is preferably a carbide containing at least one metal of metals that belong to any of 4A, 5A, 6A, 7A, 8, and 3B groups in a short-form periodic table. With these carbides, a single-phase porous carbon material having a desired pore structure can be generated at a high yield. A metal carbide containing one metal may be used solely, a complex carbide containing a plurality of metals may be used, or a plurality of metal carbides may be mixed and used. Among those described above, the metal contained in the metal carbide is preferably at least any one of titanium, aluminum, and tungsten. This is because these metals are cheap and a desired pore structure is easily obtained therewith.

Specific examples of the metal carbide include Al₄C₃, TiC, WC, ThC₂, Cr₃C₂, Fe₃C, UC₂, and MoC. Among those described above, TiC is cheap, and a desired pore structure is easily obtained with Al₄C₃.

The activation (i) using chlorine can include a step of heating the metal carbide in an atmosphere containing chlorine at a first temperature that is a relatively low temperature (e.g., at a temperature of not higher than 1100° C. or a temperature of lower than 1000° C.) (hereinafter, low-temperature chlorination). Thus, a metal chloride is released from the carbon precursor, and a carbon intermediate having a porous structure suitable for conversion to mesopores is obtained. Therefore, a carbon intermediate having a BET specific surface area of not less than 1000 m²/g and a large total pore volume can be easily obtained at low cost. The low-temperature chlorination is preferably performed at 900° C. or higher from the standpoint of inhibiting remaining of metal.

The activation can be performed in an atmosphere containing only chlorine gas. However, the activation may be performed in a mixed gas atmosphere of chlorine gas and inert gas.

In the step (ii) of causing the graphite structure to grow, similarly to the first embodiment, the carbon intermediate is heated in a substantially oxygen-free atmosphere at a temperature at which the graphite structure grows. A preferable range of the heating temperature depends on the type of the carbon precursor. In the case where, for example, TiC is used as the carbon precursor, the graphite structure is preferably caused to grow at 1150° C. to 1500° C. Meanwhile, in the case where Al₄C₃ is used as the carbon precursor, the graphite structure is preferably caused to grow at 1000° C. to 1500° C. From the standpoint of increasing the ratio of mesopores, the heating temperature is preferably not lower than 1200° C., further preferably not lower than 1300° C., and particularly preferably not lower than 1400° C. However, as the heating temperature increases, the specific surface area decreases. In addition, in the case where TiC is used as the carbon precursor, when the heating temperature exceeds 1300° C., the total pore volume tends to be small. In the case where Al₄C₃ is used as the carbon precursor, even when heating temperature exceeds 1300° C., such a tendency is not observed.

### Third Embodiment

In the present embodiment, a metal carbide is used as the carbon precursor, and the activation and the step of causing the graphite structure to grow are performed in parallel in an atmosphere containing chlorine. Specifically, the activation can include a step of heating the metal carbide in an atmosphere containing chlorine at a temperature at which the graphite structure grows (hereinafter, high-temperature chlorination). With the high-temperature chlorination, the activation (the above step (i)) and the step of causing the graphite structure to grow (the above step (ii)) proceed in parallel (or simultaneously). That is, a single-phase porous carbon material can be obtained through a one-stage reaction from the carbon precursor, not through a two-stage reaction of the above step (i) and the above step (ii).

The high-temperature chlorination can be performed in the same manner as the low-temperature chlorination, except that the heating temperature is different therebetween. Also here, in the case where TiC is used as the carbon precursor, heating is preferably performed at 1150° C. to 1500° C. Meanwhile, in the case where Al₄C₃ is used as the carbon precursor, heating is preferably performed at 1000° C. to 1500° C. In addition, from the standpoint of increasing the ratio of mesopores, the heating temperature is preferably not lower than 1200° C., further preferably not lower than 1300° C., and particularly preferably not lower than 1400° C.

[Lithium Ion Power Storage Device]

The lithium ion power storage device includes: a positive electrode containing a positive electrode active material; a negative electrode containing the above negative electrode material as a negative electrode active material; a separator interposed between the positive electrode and the negative electrode; and a nonaqueous electrolyte containing a salt of an anion and a lithium ion. In the case where the positive electrode active material contains a material capable of electrochemically occluding and releasing lithium ions (e.g., a transition metal compound), a lithium ion secondary battery with high output is obtained. In addition, in the case where the positive electrode active material contains a material capable of adsorbing and desorbing the anion in the nonaqueous electrolyte (e.g., a porous carbon material such as activated carbon), a lithium ion capacitor with high output is obtained.

Hereinafter, an example of a lithium ion capacitor will be described.

(Negative Electrode)

The negative electrode can include: a negative electrode mixture containing a negative electrode active material; and a negative electrode current collector holding the negative electrode mixture. Here, the negative electrode active material contains a single-phase porous carbon material. The negative electrode current collector is preferably, for example, a copper foil, a copper alloy foil, or the like. The negative electrode is obtained by applying a slurry obtained by mixing the negative electrode mixture and a liquid dispersion medium, to the negative electrode current collector, then removing the dispersion medium included in the slurry, and rolling the negative electrode current collector holding the negative electrode mixture as necessary. The negative electrode mixture may include a binder, a conduction aid, etc. in addition to the negative electrode active material. As the dispersion medium, for example, an organic solvent such as N-methyl-2-pyrrolidone (NMP), water, or the like is used.

The type of the binder is not particularly limited, and, for example, fluorine resins such as polyvinylidene fluoride (PVdF); rubber polymers such as styrene-butadiene rubber; cellulose derivatives such as carboxymethyl cellulose, and the like may be used. The amount of the binder is not particularly limited, and is, for example, 0.5 to 10 parts by mass per 100 parts by mass of the negative electrode active material.

The type of the conduction aid is not particularly limited, and examples thereof include carbon black such as acetylene black and Ketchen black. The amount of the conduction aid is not particularly limited, and is, for example, 0.1 to 10 parts by mass per 100 parts by mass of the negative electrode active material.

(Positive Electrode)

The positive electrode can include: a positive electrode mixture containing a positive electrode active material; and a positive electrode current collector holding the positive electrode mixture. As the positive electrode active material, for example, activated carbon having a large specific surface area is used. The positive electrode current collector is preferably, for example, an aluminum foil, an aluminum alloy foil, or the like. The positive electrode is obtained by applying a slurry obtained by mixing the positive electrode mixture and a liquid dispersion medium, to the positive electrode current collector, and then through the same step as for the negative electrode. The positive electrode mixture may include a binder, a conduction aid, etc. As the binder, the conduction aid, the dispersion medium, etc., the above materials may be used.

Examples of the material of the activated carbon include wood; palm shell; pulping waste liquor; coal or coal pitch obtained by thermally decomposing coal; heavy oil or petroleum pitch obtained by thermally decomposing heavy oil; and phenol resin.

In the lithium ion capacitor, in order to decrease the potential of the negative electrode, the negative electrode active material is preferably doped with lithium in advance. For example, lithium metal is put into a capacitor container together with the positive electrode, the negative electrode, and the nonaqueous electrolyte, and the assembled capacitor is kept warm in a thermostatic chamber at about 60° C., whereby lithium ions are eluted from the lithium metal and occluded by the negative electrode active material. The amount of lithium with which the negative electrode active material is doped is preferably an amount in which 10% to 75% of a negative electrode capacity (the reversible capacity of the negative electrode):Cₙ is filled with lithium.

(Separator)

By interposing the separator between the positive electrode and the negative electrode, short circuiting between the positive electrode and the negative electrode is inhibited. As the separator, a microporous film, a nonwoven fabric, or the like is used. As the material of the separator, for example, polyolefins such as polyethylene and polypropylene; polyesters such as polyethylene terephthalate; polyamides; polyimides; cellulose; glass fibers; and the like may be used. The thickness of the separator is about 10 to 100 μm.

(Nonaqueous Electrolyte)

The nonaqueous electrolyte is not particularly limited as long as the nonaqueous electrolyte has lithium ion conductivity. A general nonaqueous electrolyte contains: a salt (lithium salt) of an anion and a lithium ion; and a nonaqueous solvent that dissolves the lithium salt. The concentration of the lithium salt in the nonaqueous electrolyte may be, for example, 0.3 to 3 mol/L.

Examples of the anion forming the lithium salt include anions of fluorine-containing acids [fluorine-containing phosphoric acid anions such as hexafluorophosphoric acid ion (PF₆⁻); fluorine-containing boric acid anions such as tetrafluoroboric acid ion (BF₄⁻)]; anions of chlorine-containing acids [perchloric acid ion (ClO₄⁻), etc.]; and bissulfonylimide anions (bissulfonylimide anion containing a fluorine atom, etc.). The nonaqueous electrolyte may contain one of these anions, or may contain two or more of these anions.

As the nonaqueous solvent, for example, cyclic carbonates such as ethylene carbonate (EC), propylene carbonate, and butylene carbonate; chain carbonates such as dimethyl carbonate, diethyl carbonate (DEC), ethyl methyl carbonate; and lactones such as γ-butyrolactone and γ-valerolactone; and the like may be used. As the nonaqueous solvent, one of these solvents may be used solely, or two or more of these solvents may be used in combination.

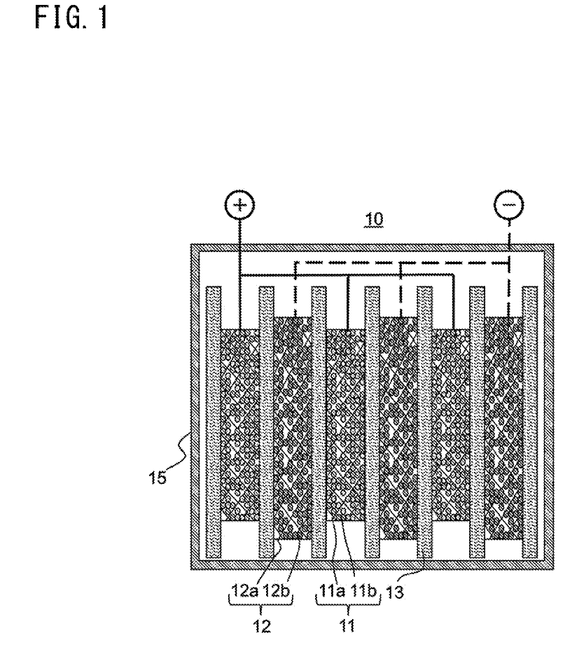

FIG. 1 schematically shows the configuration of an example of the lithium ion capacitor. An electrode assembly and a nonaqueous electrolyte that are main components of a capacitor 10 are housed within a cell case 15. The electrode assembly is configured by stacking a plurality of positive electrodes 11 and a plurality of negative electrodes 12 with separators 13 interposed therebetween. Here, each positive electrode 11 includes: a positive electrode current collector 11a that is a metal porous body; and a particulate positive electrode active material 11b that fills the positive electrode current collector 11a. In addition, each negative electrode 12 includes: a negative electrode current collector 12a that is a metal porous body; and a particulate negative electrode active material 12b that fills the negative electrode current collector 12a.

Next, an example of a lithium ion secondary battery will be described.

As a negative electrode, a nonaqueous electrolyte, and a separator of a lithium ion secondary battery, components that are the same as those of the lithium ion capacitor may be used. Meanwhile, as a positive electrode active material, a material that causes a Faradaic reaction associated with occlusion and release of lithium ions is used. Such a material is preferably, for example, a lithium-containing transition metal compound. Specifically, lithium phosphate having an olivine structure, lithium manganate having a spinel structure, lithium cobaltate or lithium nickelate having a layered structure (O3 type structure), etc. are preferable.

A positive electrode for the lithium ion secondary battery is obtained by applying a slurry obtained by mixing a positive electrode mixture and a liquid dispersion medium, to a positive electrode current collector, and then through the same step as described above. The positive electrode mixture may contain a binder, a conduction aid, etc. Also as the binder, the conduction aid, the dispersion medium, etc., materials that are the same as described above may be used.

Hereinafter, the present invention will be described further specifically on the basis of examples and comparative examples, but is not limited to the following examples.

### Example 1

(1) Manufacture of Single-Phase Porous Carbon Material

A single-phase porous carbon material that is a negative electrode material was produced by the following procedure.

A metal carbide (TiC or Al₄C₃) having an average particle diameter of 10 μm was set on a placement shelf made of carbon in an electric furnace including a furnace tube made of quartz glass. Then, mixed gas of chlorine and nitrogen (Cl₂ concentration: 10 mol %) was caused to flow into the furnace tube at normal pressure, and a metal carbide and chlorine were reacted with each other at 1000° C. to 1400° C. for four hours. In the case of using TiC, activation at 1000° C. and 1100° C. corresponds to low-temperature chlorination, and activation at 1200° C. to 1400° C. corresponds to high-temperature chlorination. Meanwhile, in the case of using Al₄C₃, activation at 1000° C. or higher all corresponds to high-temperature chlorination.

A cold trap at −20° C. was provided to the reaction system, and a metal chloride was liquefied by the cold trap and recovered. Chlorine gas that was not reacted in the furnace tube was refluxed to the furnace tube with a three-way valve provided at the outlet side of the cold trap. Thereafter, the chlorine gas in the furnace tube was removed with nitrogen gas, and the temperature of the placement shelf made of carbon was decreased to 500° C. Next, mixed gas of hydrogen and argon was caused to flow at normal pressure, and the single-phase porous carbon material was heated at 500° C. for one hour. Thereafter, the single-phase porous carbon material left on the placement shelf was taken out into the air.

A lithium ion capacitor was produced by the following procedure.

(2) Production of Positive Electrode

A positive electrode mixture slurry was prepared by mixing and agitating 86 parts by mass of a commercially available palm shell activated carbon (specific surface area: 1700 m²/g), 7 parts by mass of Ketchen black, which is a conduction aid, 7 parts by mass of polyvinylidene fluoride (PVdF), which is a binder, and an appropriate amount of N-methyl-2-pyrrolidone (NMP) as a dispersion medium with a mixer. The positive electrode mixture slurry was applied to one surface of an aluminum foil (thickness: 20 μm), which is a current collector, and was dried, and then the aluminum foil was rolled to form a positive electrode mixture coating film with a thickness of 100 μm, thereby forming a positive electrode.

(3) Production of Negative Electrode

A negative electrode mixture slurry was prepared by mixing and agitating 86 parts by mass of the single-phase porous carbon material derived from each of TiC and Al₄C₃ (average particle diameter: 10 μm), 7 parts by mass of acetylene black, which is a conduction aid, 7 parts by mass of PVDF, which is a binder, and an appropriate amount of NMP as a dispersion medium with a mixer. The negative electrode mixture slurry was applied to one surface of a copper foil (thickness: 15 μm), which is a current collector, and was dried, and then the copper foil was rolled to form a coating film with a thickness of 70 μm, thereby forming a negative electrode.

(4) Assembling of Lithium Ion Capacitor

Each of the positive electrode and the negative electrode was cut out into a size of 1.5 cm×1.5 cm, and a lead made of aluminum and a lead made of nickel were welded to the positive electrode current collector and the negative electrode current collector, respectively.

A separator made of cellulose (thickness: 30 μm) was interposed between the positive electrode and the negative electrode, and the positive electrode mixture and the negative electrode mixture were opposed to each other, to form an electrode assembly of a single cell. It should be noted that a lithium foil (thickness: 20 μm) was interposed between the negative electrode mixture and the separator. Thereafter, the electrode assembly was put into a cell case produced from an aluminum laminate sheet.

Next, a nonaqueous electrolyte was injected into the cell case to impregnate the positive electrode, the negative electrode, and the separator therewith. As the nonaqueous electrolyte, a solution obtained by dissolving LiPF₆ as a lithium salt at a concentration of 1.0 mol/L in a mixed solvent containing EC and DEC in a volume ratio of 1:1 was used. Finally, the cell case was sealed by a vacuum sealer while the pressure therein is reduced, and also pressure was applied to two opposite surfaces of the cell case to ensure adhesiveness between the positive and negative electrodes and the separator.

[Evaluation]

For the single-phase porous carbon materials, the following evaluation (a) to (e) was made. In addition, for the lithium ion capacitors, the following evaluation (f) was made.

(a) X-Ray Diffraction (XRD) Measurement

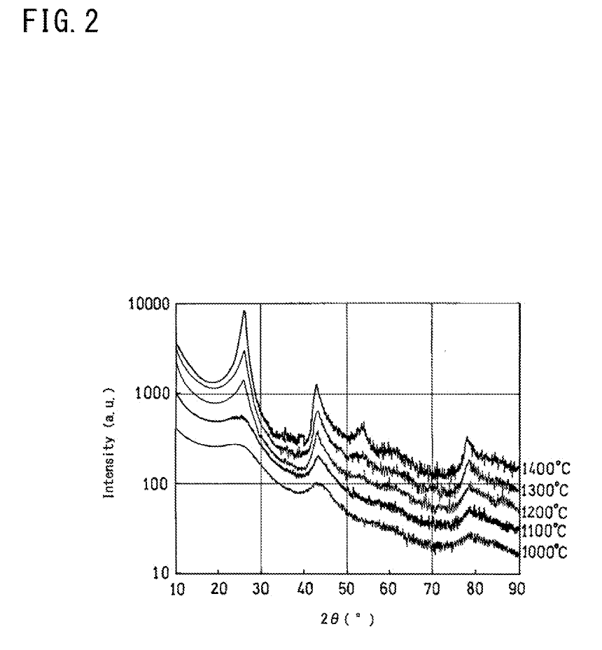

An X-ray diffraction image of each single-phase porous carbon material by Cu Kα radiation was measured. In the X-ray diffraction image, a peak (P₀₀₂) ascribed to the (002) plane of graphite was observed at approximately 2θ=26°. FIG. 2 shows the results of measurement of the single-phase porous carbon material derived from TiC. When the chlorination temperature is equal to or higher than 1200° C., the peak (P₀₀₂) of the (002) plane particularly sharply appears.

Hereinafter, samples of the TiC-derived single-phase porous carbon material obtained through chlorination at 1000° C., 1100° C., 1200° C., 1300° C., and 1400° C. are referred to as sample A1, sample B1, sample C1, sample D1, and sample E1, respectively. Similarly, samples of the Al₄C₃-derived single-phase porous carbon material obtained through chlorination at 1000° C., 1200° C., and 1400° C. are referred to as sample A2, sample C2, and sample E2, respectively.

A sample obtained by baking the sample A1 in an inert gas (Ar) atmosphere at 1200° C. exhibited an X-ray diffraction image that is substantially the same as that of the sample C1. This indicates that even when low-temperature chlorination is performed at 1000° C., if a step of causing graphite to grow at a higher temperature is performed, a crystal structure that is the same as that with high-temperature chlorination is obtained.

(b) Plane Interval (d₀₀₂) of (002) Plane of Graphite

The background was removed from the X-ray diffraction image, and then a plane interval (d₀₀₂) of the (002) plane was obtained by using a formula: d₀₀₂=λ/2 sin (θx) from the position (2θx) of the midpoint of the peak width at ⅔ of the height of the peak (P₀₀₂).

(c) Crystallite Size of Graphite

A crystallite size (Lc) was obtained by using a formula: Lc=λ/β cos (θx) from the half width β of the peak (P₀₀₂).

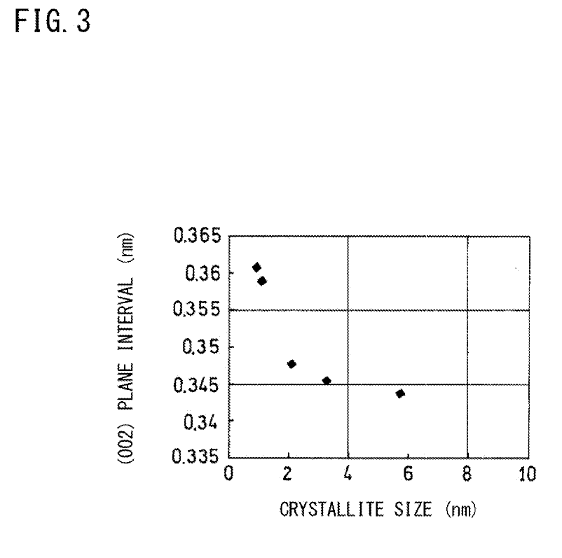

FIG. 3 shows a relationship between the crystallite size (Lc) of the graphite contained in the single-phase porous carbon material derived from TiC and the plane interval (d₀₀₂) of the (002) plane. The plots in FIG. 3 correspond to the sample A1 to the sample E1 in order from a smaller crystallite size. From FIG. 3, it can be understood that the plane interval decreases as the crystallite size increases. In addition, it can be understood that when the chlorination temperature is equal to or higher than 1200° C., the plane interval is significantly small.

(d) BET Specific Surface Area

An adsorption isotherm of N₂ at −196° C. was measured by using BELLSORP-mini II manufactured by Bell Japan, Inc., and the BET specific surface area of each single-phase porous carbon material was obtained. For QSDFT analysis, an adsorption isotherm of N₂ was similarly measured by using Nova 2000 manufactured by Quantachrome Instruments.

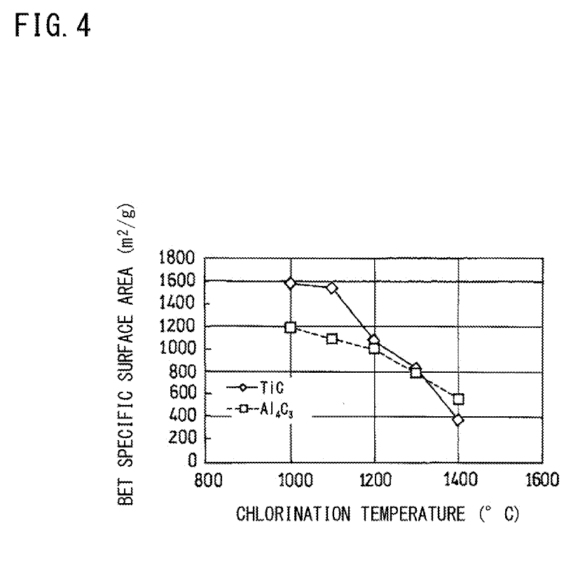

FIG. 4 shows a relationship between the chlorination temperature and the BET specific surface area of each single-phase porous carbon material. A tendency is observed that the BET specific surface area decreases as the chlorination temperature increases. However, the BET specific surface area is sufficiently large even at 1400° C. and is maintained to be about 300 m²/g or greater.

(e) Pore Diameter Distribution

A pore diameter distribution of each single-phase porous carbon material was obtained by applying a BJH method to the above adsorption isotherm, the total pore volume and the volume of mesopores of 2 nm to 50 nm were obtained from the pore diameter distribution, and further the ratio of the mesopore volume was obtained.

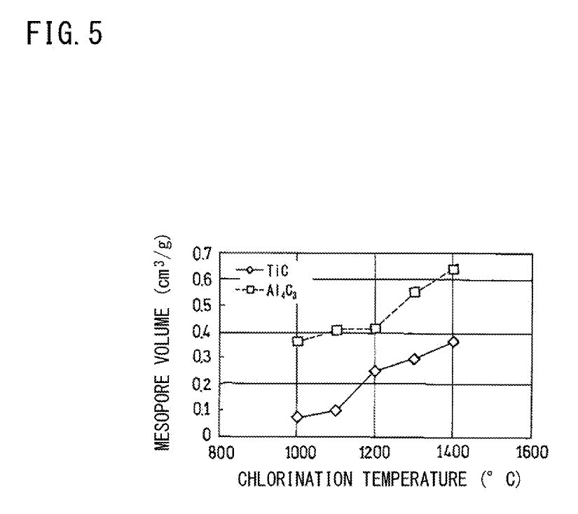

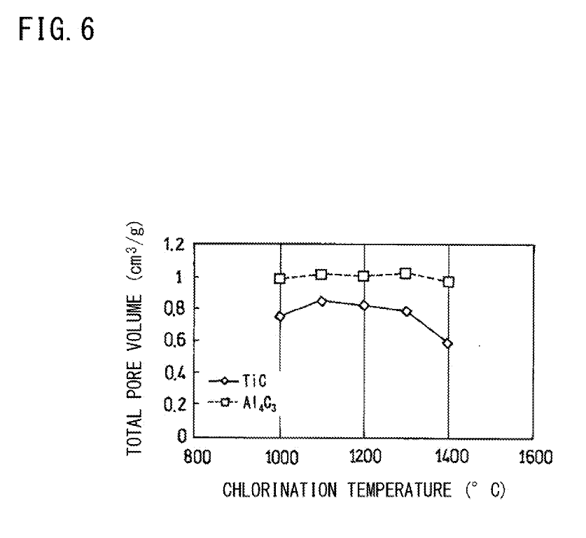

FIGS. 5 and 6 show relationships between the chlorination temperature and the mesopore volume and the total pore volume formed in each single-phase porous carbon material. FIG. 5 shows that at least until 1400° C., the mesopore volume increases as the chlorination temperature increases.

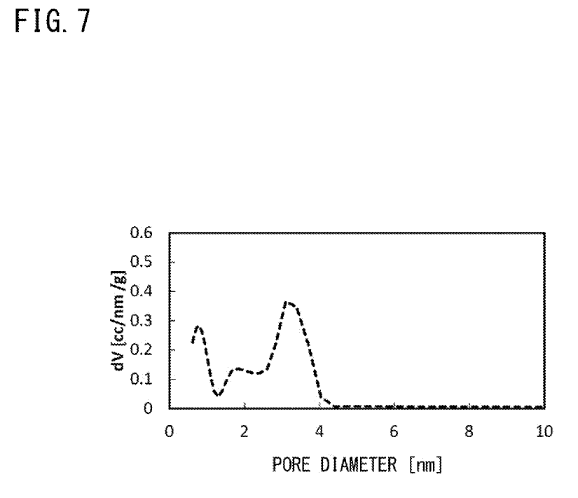

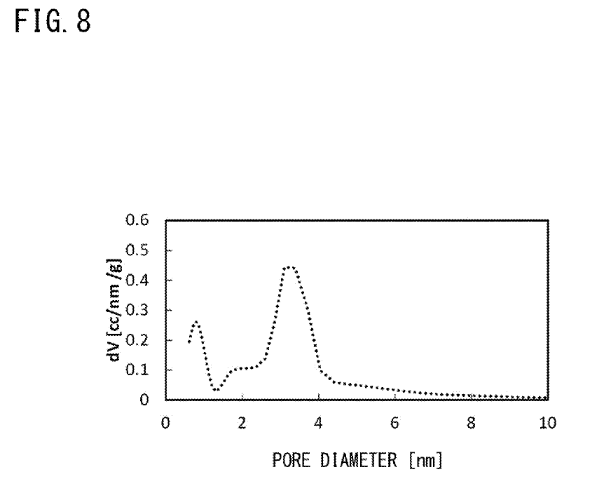

FIGS. 7 and 8 each show a pore diameter distribution analyzed by the QSDFT method. The measured samples are the sample D1 and the sample C2, FIG. 7 shows the results of analysis of the sample D1, and FIG. 8 shows the results of analysis of the sample C2. In the case of the TiC material, there is a pore peak at 3 nm to 4 nm, and this is the same also with the Al₄C₃ material. Such a structure cannot be observed with commercially available activated carbon.

(f) Output Characteristics

Each lithium ion capacitor was charged to a voltage of 4.0 V at a current of 1.0 mA, and was discharged to a voltage 3.0 V at a predetermined current value (1.0 mA, 100 mA, or 500 mA). A discharge capacity (C₁) obtained at 1.0 mA was regarded as 100, and discharge capacities (C₁₀₀ and C₅₀₀) obtained at 100 mA and 500 mA were standardized. A value closer to 100 indicates a higher capacity.

TABLE 1

| No. | Precursor | T1 | T2 | C₁ | C₁₀₀ | C₅₀₀ | Va | Vm | R | S | L_{C} | d₀₀₂ |
|---|---|---|---|---|---|---|---|---|---|---|---|---|
| A1 | TiC | 1000 | | 100 | 70 | 22 | 0.75 | 0.07 | 9 | 1600 | 0.9 | 0.360 |
| B1 | TiC | 1100 | | 100 | 76 | 27 | 0.85 | 0.10 | 12 | 1550 | 1.1 | 0.359 |
| C1 | TiC | 1200 | | 100 | 86 | 55 | 0.82 | 0.25 | 30 | 1080 | 2.1 | 0.348 |
| D1 | TiC | 1300 | | 100 | 91 | 70 | 0.78 | 0.30 | 38 | 840 | 3.3 | 0.346 |
| E1 | TiC | 1400 | | 100 | 89 | 66 | 0.59 | 0.36 | 61 | 380 | 5.8 | 0.343 |
| A2 | Al₄C₃ | 1000 | | 100 | 84 | 53 | 0.99 | 0.36 | 36 | 1190 | 3.7 | 0.344 |
| C2 | Al₄C₃ | 1200 | | 100 | 90 | 68 | 1.00 | 0.41 | 41 | 1000 | 3.7 | 0.344 |
| E2 | Al₄C₃ | 1400 | | 100 | 88 | 65 | 0.97 | 0.64 | 66 | 550 | 3.9 | 0.342 |
| X | Soft-C | 800 | 1350 | 100 | 81 | 38 | 0.50 | 0.35 | 70 | 500 | 10 | 0.340 |

| | | | | | | | | | | | |
|---|---|---|---|---|---|---|---|---|---|---|---|
| Y | Graphite | — | 100 | 70 | 21 | — | — | — | — | 100 | 0.335 |
| Z | Hard-C | — | 100 | 74 | 25 | — | — | — | — | 2.2 | 0.39 |

Examples in which the samples A1, B1, Y, and Z were used are comparative examples.

T1: temperature (° C.) of activation

T2: graphite growth temperature (° C.)

Va: total pore volume (cm³/g)

Vm: mesopore volume (cm³/g)

R: 100×Vm/Va (%)

S: BET specific surface area (m²/g)

Lc: crystallite size (nm)

d₀₀₂: plane interval (nm) of (002) plane

Soft-C: easily-graphitizable carbon

Hard-C: hardly-graphitizable carbon

### Example 2

A lithium ion capacitor was produced and evaluated in the same manner as in Example 1, except for using a single-phase porous carbon material (sample X) derived from easily-graphitizable carbon, instead of the single-phase porous carbon material derived from the metal carbide. The results are shown in Table 1.

The single-phase porous carbon material derived from easily-graphitizable carbon was produced by the following procedure.

First, in a pressure-reduced atmosphere, petroleum pitch was heated at 1000° C. for five hours to be carbonized, to obtain easily-graphitizable carbon (carbonized pitch) that is a carbon precursor. Next, the easily-graphitizable carbon was activated at 800° C. in an atmosphere containing water vapor (H/C gas), to obtain a carbon intermediate. Next, the carbon intermediate was heated in a nitrogen atmosphere at 1350° C. to cause a graphite structure to grow, to obtain the single-phase porous carbon material.

### Comparative Example 1

A lithium ion capacitor was produced and evaluated in the same manner as in Example 1, except for using commercially available artificial graphite (plane interval (d₀₀₂)=0.335 nm, the sample Y) instead of the single-phase porous carbon material. The results are shown in Table 1.

### Comparative Example 2

A lithium ion capacitor was produced and evaluated in the same manner as in Example 1, except for using commercially available hardly-graphitizable carbon (hard carbon) (plane interval (d₀₀₂)=0.39 nm, the sample Z) instead of the single-phase porous carbon material. The results are shown in Table 1.

From Table 1, it can be understood that a power storage device with high output is obtained by using a single-phase porous carbon material that has a specific surface area of not less than 100 m²/g and in which the cumulative volume (mesopore volume) of pores having a pore diameter of 2 nm to 50 nm is not less than 25% of the total pore volume. It can be understood that in the case where TiC is used as the carbon precursor, the graphite is preferably caused to grow at 1200° C. or higher, further at 1300° C. or higher.

### INDUSTRIAL APPLICABILITY

The negative electrode material for the lithium ion power storage device according to the present invention has a pore structure suitable for movement of lithium ions, and thus can achieve high output. Therefore, the negative electrode material is applicable to various power storage devices required to have a high capacity.

### REFERENCE SIGNS LIST

10 capacitor
11 positive electrode
11a positive electrode current collector
11b positive electrode active material
12 negative electrode
12a negative electrode current collector
12b negative electrode active material
13 separator
15 cell case

1. A negative electrode material for a power storage device, containing a single-phase porous carbon material capable of electrochemically occluding and releasing lithium ions, wherein
the single-phase porous carbon material has a BET specific surface area of not less than 100 m²/g, and
a cumulative volume of pores having a pore diameter of 2 nm to 50 nm in a pore diameter distribution of the single-phase porous carbon material is not less than 25% of a total pore volume.

2. The negative electrode material for the power storage device according to claim 1, wherein
an X-ray diffraction image of the single-phase porous carbon material has a peak ascribed to a (002) plane of graphite,
a plane interval of the (002) plane obtained from a position of the peak is 0.340 nm to 0.370 nm, and
a crystallite size of the graphite obtained from a half width of the peak is 1 nm to 20 nm.

3. The negative electrode material for the power storage device according to claim 1, wherein the total pore volume is 0.3 cm³/g to 1.2 cm³/g.

4. The negative electrode material for the power storage device according to claim 1, wherein the pore diameter distribution of the single-phase porous carbon material has at least one pore distribution peak in a region of 2 nm to 5 nm in pore distribution analysis in QSDFT analysis that assumes a carbon slit structure.

5. A method for manufacturing a negative electrode material for a power storage device, the method comprising:
(i) a step of activating a carbon precursor in which a graphite structure grows at a temperature of not higher than 1500° C., into a porous structure; and
(ii) heating the activated carbon precursor at a temperature at which the graphite structure grows, to cause the graphite structure to grow to generate a single-phase porous carbon material.

6. The method for manufacturing the negative electrode material for the power storage device according to claim 5, wherein
the carbon precursor is easily-graphitizable carbon, and
the activation includes a step of heating the carbon precursor at a temperature of lower than 1100° C. in an atmosphere containing water vapor and/or carbon dioxide.

7. The method for manufacturing the negative electrode material for the power storage device according to claim 6, wherein the easily-graphitizable carbon is generated by carbonizing a precursor at a temperature of lower than 1000° C.

8. The method for manufacturing the negative electrode material for the power storage device according to claim 5, wherein
the carbon precursor is a metal carbide, and
the activation includes a step of heating the metal carbide at a first temperature in an atmosphere containing chlorine.

9. The method for manufacturing the negative electrode material for the power storage device according to claim 8, wherein the step of causing the graphite structure to grow includes a step of heating the activated carbon precursor in a substantially oxygen-free atmosphere at a second temperature higher than the first temperature.

10. The method for manufacturing the negative electrode material for the power storage device according to claim 5, wherein
the carbon precursor is a metal carbide,
the activation includes heating the metal carbide in an atmosphere containing chlorine at a temperature at which the graphite structure grows, and
the activation and the step of causing the graphite structure to grow are performed in parallel.

11. The method for manufacturing the negative electrode material for the power storage device according to claim 8, wherein the metal carbide is a carbide containing at least one metal of metals that belong to any of 4A, 5A, 6A, 7A, 8, and 3B groups in a short-form periodic table.

12. The method for manufacturing the negative electrode material for the power storage device according to claim 11, wherein the metal is at least any one of titanium, aluminum, and tungsten.

13. The method for manufacturing the negative electrode material for the power storage device according to claim 5, wherein the activated carbon precursor has a BET specific surface area of not less than 1000 m²/g.

14. The method for manufacturing the negative electrode material for the power storage device according to claim 5, wherein
the single-phase porous carbon material has a BET specific surface area of not less than 100 m²/g, and
a cumulative volume of pores having a pore diameter of 2 nm to 50 nm in a pore diameter distribution of the single-phase porous carbon material is not less than 25% of a total pore volume.

15. The method for manufacturing the negative electrode material for the power storage device according to claim 5, wherein
an X-ray diffraction image of the single-phase porous carbon material has a peak ascribed to a (002) plane of graphite,
an average of a plane interval of the (002) plane obtained from a position of the peak is 0.340 nm to 0.370 nm, and
a crystallite size of the graphite obtained from a half width of the peak is 1 nm to 20 nm.

16. The method for manufacturing the negative electrode material for the power storage device according to claim 5, wherein a total pore volume of the single-phase porous carbon material is 0.3 cm³/g to 1.2 cm³/g.

17. The method for manufacturing the negative electrode material for the power storage device according to claim 14, wherein the pore diameter distribution of the single-phase porous carbon material has at least one pore distribution peak in a region of 2 nm to 5 nm in pore distribution analysis in QSDFT analysis that assumes a carbon slit structure

18. The method for manufacturing the negative electrode material for the power storage device according to claim 5, further comprising a step of heating the single-phase porous carbon material in a temperature range of 500° C. to 800° C. in an atmosphere containing water vapor and/or hydrogen, after the step of causing the graphite structure to grow.

19. A lithium ion power storage device comprising: a positive electrode containing a positive electrode active material; a negative electrode containing a negative electrode active material; a separator interposed between the positive electrode and the negative electrode;
and a nonaqueous electrolyte containing a salt of an anion and a lithium ion, wherein the negative electrode active material contains the negative electrode material for the power storage device according to claim 1.
